(19) United States
(12) Patent Application Publication
(10) Pub. No.: US 2016/0090752 A1
(43) Pub. Date: Mar. 31, 2016

(54) SELF-LEARNING LOCK AND LOCK ASSEMBLY APPARATUS

(71) Applicant: RB Distribution, Inc., Colmar, PA (US)

(72) Inventors: Marc MCCANN, Philadelphia, PA (US); Brandon GRAVER, Lansdale, PA (US); Stephen R. IDE, Nazareth, PA (US)

(73) Assignee: RB DISTRIBUTION, INC., Colmar, PA (US)

(21) Appl. No.: 14/869,382

(22) Filed: Sep. 29, 2015

Related U.S. Application Data
(60) Provisional application No. 62/056,918, filed on Sep. 29, 2014.

(51) Int. Cl. E05B 19/00; E05B 27/00

(52) U.S. Cl. CPC E05B 19/0011; E05B 27/0017; E05B 27/005

(57) ABSTRACT

A self-learning lock cylinder assembly or lock tumbler and tools capable of teaching the self-learning key configuration of a pre-existing key is disclosed. The individual performing the self-learning does not need to have prior locksmith experience. The individual performing the self-learning procedure can verify that the original key and copies of the original key function properly within the lock cylinder prior to final assembly and installation in the lock through a self-learning test housing. The pre-installation testing eliminates problems associated with an incorrectly assembled lock cylinder

### FIELD OF INVENTION

The present invention relates to lock assemblies that can be programed to accept an existing key. Locks of this type are generally referred to as adaptable to being rekeyed.

### BACKGROUND

Current lock cylinders and mating keys often wear from repeated use or may be otherwise damaged and need to be replaced. This problem is especially evident in the area of automotive ignitions. A problem arises with replacement of the lock cylinder in an automotive ignition or other similar application when the original key includes other functions such as opening doors, the trunk lid or windows. Furthermore, the original key maybe digitally coded to other automobile applications or anti-theft systems.

Current lock cylinders that can be rekeyed involve disassembly and re-assembly of internal components by a skilled user or are one-time only assemblies with no means to verify additional copies of the original key are functional after a rekeying procedure. Examples of prior attempts at solving the problems with the prior art are found in U.S. Pat. Nos. 3,589,153; 6,860,131; 7,007,528; 7,140,213; 7,213,429; 7,634,930; and 8,161,783.

There exists a need for a simplified self-learning lock assembly that enables the reuse of the original key when replacing a defective lock cylinder.

### SUMMARY

The present invention provides of a lock cylinder assembly or lock tumbler and tools capable of self-learning a key's configuration so it is usable with a pre-existing key. The individual performing the self-learning does not need to have prior locksmith experience. The individual performing the self-learning procedure can verify that the original key and copies of the original key function properly within the lock cylinder prior to final assembly and installation in the lock through a self-learning test housing. The advantage of the pre-installation testing is that it eliminates the problem associated with an incorrectly assembled lock cylinder.

### BRIEF DESCRIPTION OF THE DRAWING(S)

FIG. 1 illustrates an original key in a self-learning plug or tumbler during the learning procedure;

FIG. 2 is an exploded view of the parts assembled in FIG. 1;

FIG. 3 illustrates a self-learning wafer;

FIG. 4 illustrates and array of self-learning wafers with compression springs prior to the learning procedure;

FIG. 5 illustrates one side of a self-learning plug or tumbler prior to the learning procedure;

FIG. 6 illustrates the opposite side of a self-learning plug or tumbler in FIG. 5 prior to the learning procedure;

FIG. 7 illustrates a housing sub-assembly; and

FIG. 8 illustrates the finished plug and original key after the completion of the self-learning process.

### DETAILED DESCRIPTION OF THE PREFERRED EMBODIMENT(S)

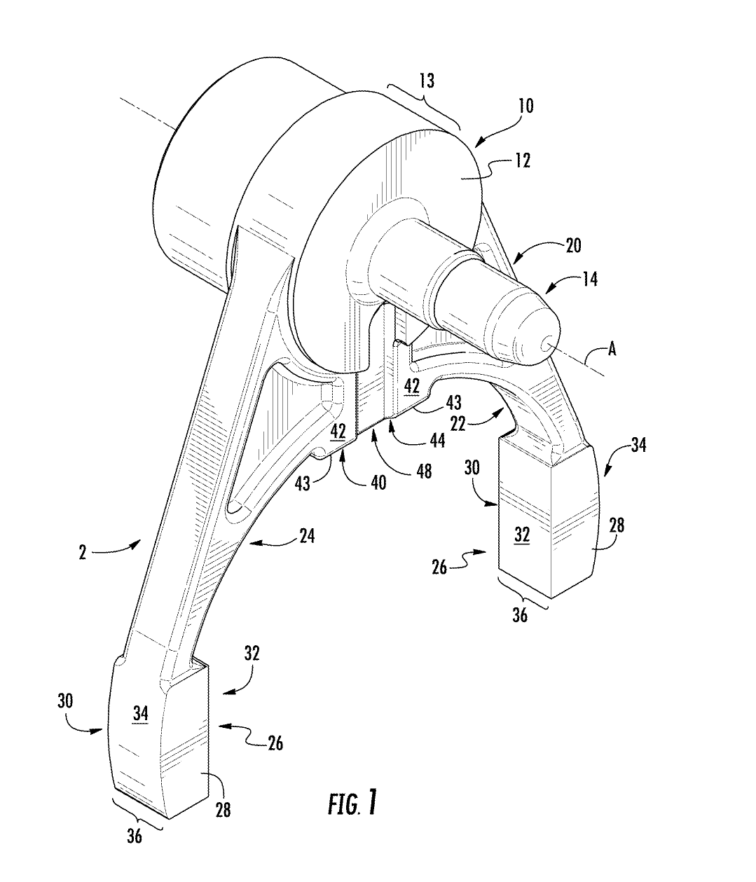

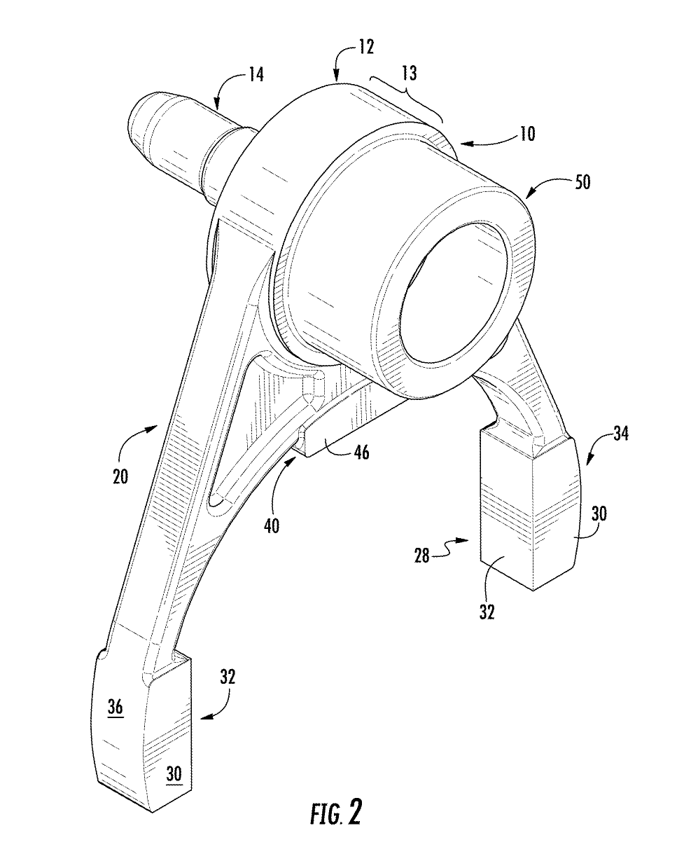

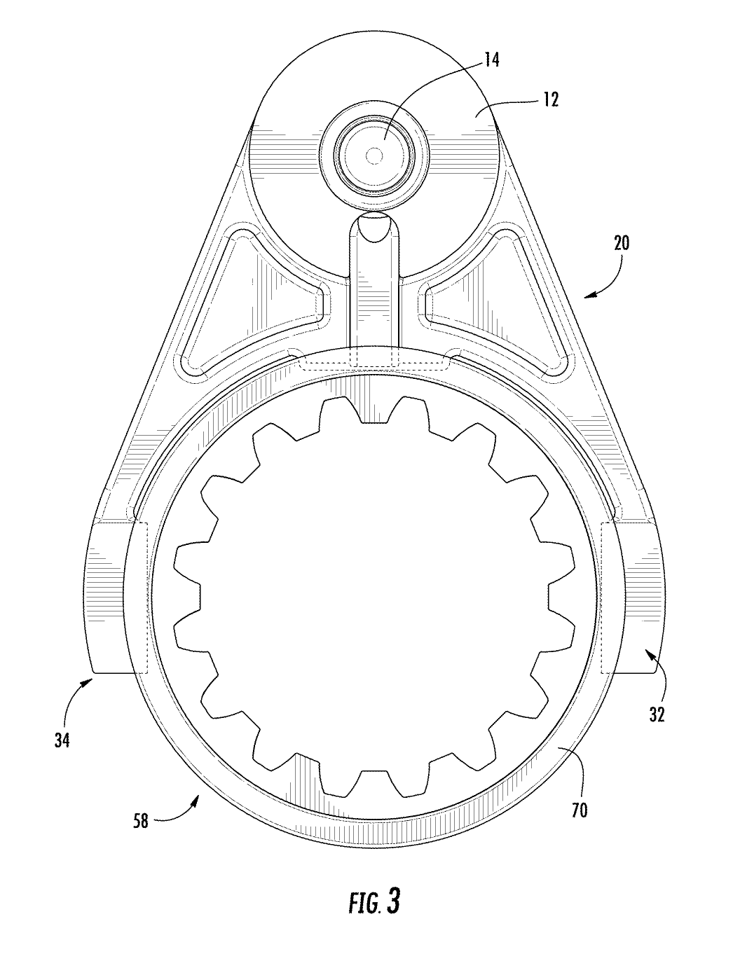

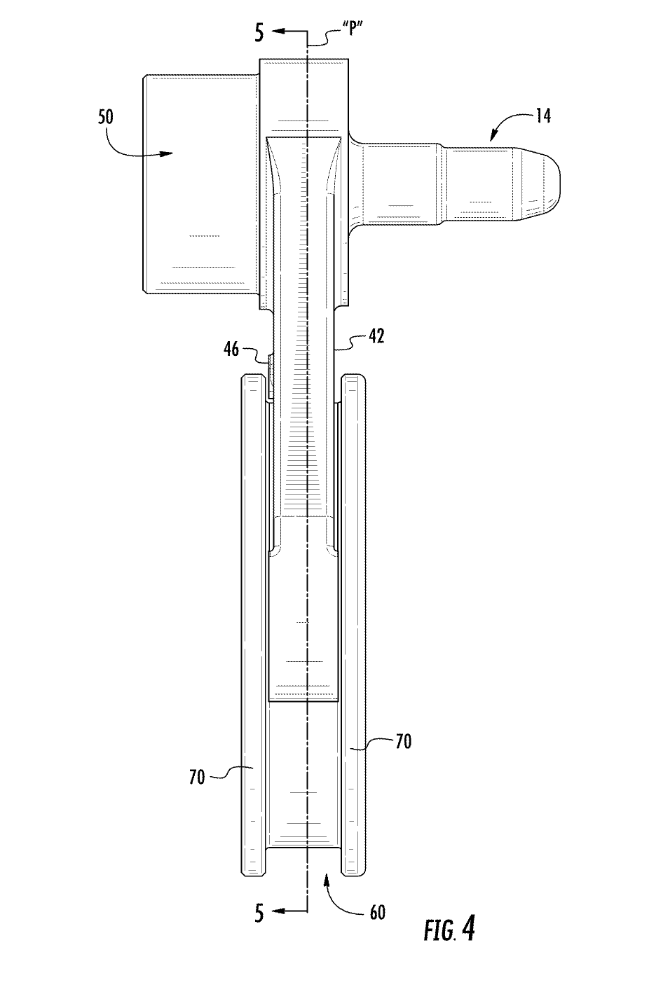

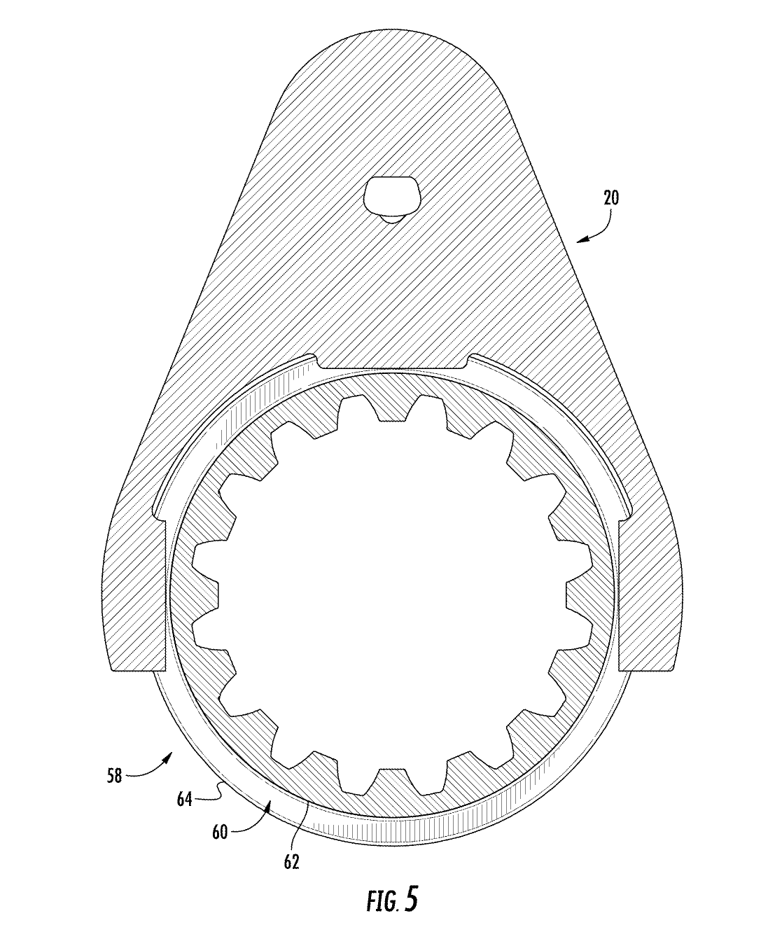

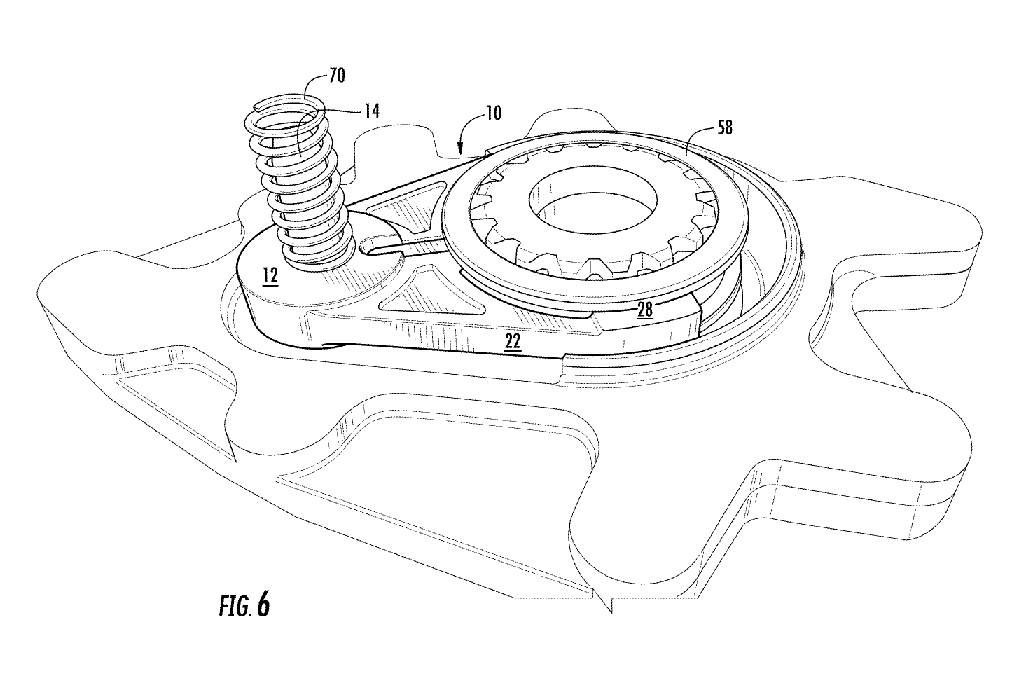

The self-learning wafer sub-assembly, FIGS. 3 and 4, enables the self-learning of the plug sub assembly in FIG. 6. The wafers have a central body 26 that includes a key window or slot 27. The opposite ends of the body 26 have learning end wafers. On one end there are external teeth that mate with a first learning wafer 28 and the other end has internal teeth that mate with a second learning wafer 30. On one side of the wafer body 26 there are notches 29 that are configured to receive the wafer holding tool shown in FIG. 1. The original key 50 with a preexisting topography passes through the key hole in the plug or tumbler 23 and into the windows or slots 27 of the wafers shown in FIG. 3. The compression springs shown in the array of self-learning wafers in FIG. 4 abut the limiting stops 32 and bias the wafers against the coding surface or topography of the original key, see FIG. 2. During the learning procedure, the wafers are locked in place by the insertion of the wafer-holding tool 24 prior to depressing. When the wafer-setting tool 22 is depressed, see FIG. 1, the wafer-setting tool sets the first group of learning wafers to the correct position to match the coding surface or associated topography of the original key. This procedure is repeated on the other side with the wafer setting tool 22, to set the second group of learning wafers.

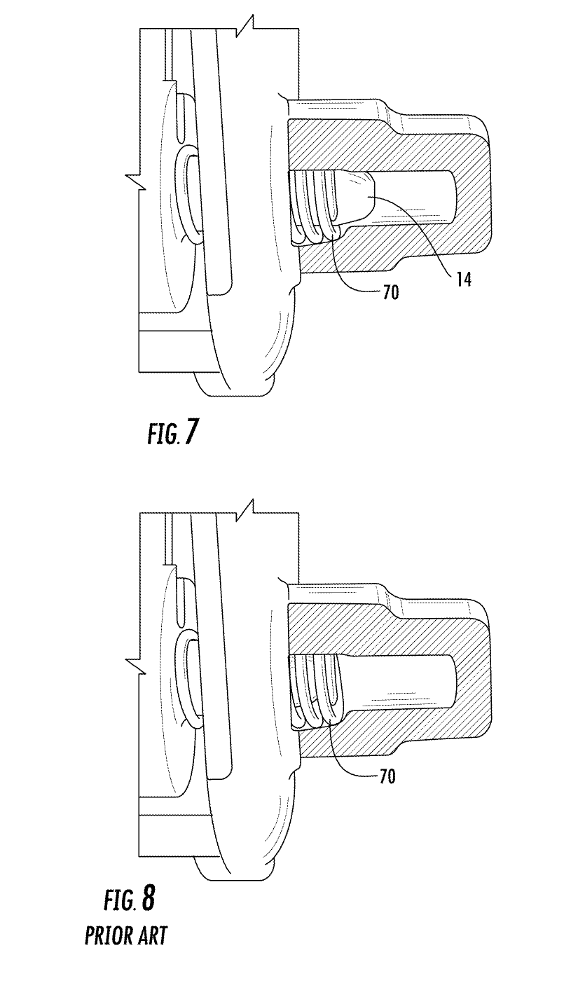

After completing the self-learning procedure with the original key still in place, the key and plug assembly can be tested for operation in the self-learning housing, shown in FIG. 1. The key and plug assembly will freely rotate from a first position to a second position. At this new position the wafer sub-assemblies cannot move radially out and the key is locked in the plug assembly. The key and plug assembly will freely rotate from a first position to a second position. The wafer sub-assemblies can move radially outward into receiving slots, see FIGS. 2 and 7, and the key will release from the plug sub-assembly.

If the keys do not function correctly, further adjustments can be made to the wafer sub-assemblies to obtain proper function. When the self-learning procedure is complete and verified, the key and plug sub-assembly is transferred to the housing of FIG. 7 and becomes the finished assembly of FIG. 8. If desired, retesting of key function can be completed within the housing to verify proper function prior to installation in the final application.

With reference to FIG. 7, the wafer receiving slots in the housing allow the wafer sub-assemblies to engage the housing prior to inserting the key. When a correctly learned key is inserted in the plug, the wafer sub-assemblies move into position according to the coding surface of the key and retract from the wafer receiving slots. The plug assembly is now free to rotate. Once the plug assembly and key are rotated past the wafer receiving slots, the wafer sub-assemblies are restricted from movement and the key is locked in place within the plug assembly.

1. A plug assembly that self learns an existing key topography, the plug assembly comprising:
a key receiving slot that receives an existing key having a predetermined topography;
a plurality of wafer receiving slots that intersect the key receiving slot;
a plurality of wafers dimensioned to be received within the wafer receiving slot, each of the wafers has a passage that is sized and align to enable the key to pass through the passage; and,
a plurality of movable learning segments associated with each wafer, and at least one biasing element associated with each wafer;
wherein the movable learning segments associated with each wafer are moved to a position associated with the predetermined key topography.

2. A self-learning lock tumbler comprising:
a tumbler body;
a slot in the tumbler body receives an existing lock key having a predetermined topography;
a plurality of wafer receiving slots that are generally arranged perpendicular to the slot;
a plurality of wafers that are received within the wafer receiving slots, each of the plurality of wafers defines a passage that is sized and align for the through passage of the key; and,
a plurality of movable learning segments that are associated with each wafer and at least one biasing element;
wherein the movable learning segments associated with each wafer are positioned according to the predetermined key topography.

3. A kit for teaching a self-learning lock tumbler comprising:
a tumbler body;
a slot in the tumbler body that receives an existing lock key having a predetermined topography;
a plurality of wafer receiving slots that are generally arranged perpendicular to the slot;
a plurality of wafers that are received within the wafer receiving slots, each of the plurality of wafers defines a passage that is sized and align for the through passage of an existing lock key;
a plurality of movable learning segments that are associated with each wafer and at least one biasing element associated with each wafer; and,
a self-learning test housing;
wherein whereby the movable learning segments associated with each wafer are positioned according to a predetermined key topography associated with an existing lock key and the wafer positioning accuracy is confirmed in the self-learning test housing.

4. The kit of claim 3 further comprising: a wafer-holding tool.

5. The kit of claim 4 further comprising: a wafer-setting tool.
